(19) United States
(12) Patent Application Publication
(10) Pub. No.: US 2007/0239540 A1
(43) Pub. Date: Oct. 11, 2007

(54) TELEVISION STATION AND ASSOCIATED CONVENTIONS DEDICATED TO SENIOR CITIZENS AND METHOD OF OPERATION

(76) Inventor: Fred Victorson, Las Vegas, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 11/688,773

(22) Filed: Mar. 20, 2007

Related U.S. Application Data
(63) Continuation-in-part of application No. 11/277,341, filed on Mar. 23, 2006.

(51) Int. Cl. G07G 1/14

(52) U.S. Cl. 705/14

(57) ABSTRACT

A television, cable or satellite channel dedicated to issues relevant to senior citizens is disclosed. The content of the channel involves programming on healthcare, politics, insurance and many related seniors' issues. Advertisements are also limited to goods and services directed to seniors. Indeed, one version limits advertisements to the subject matter of the programming during which the advertisement is run. For example, during healthcare programming only healthcare related advertisements are run. Interactive programming is also disclosed. The television channel is also ideal as a conduit providing an avenue for seniors to lodge concerns and complaints. Associated conventions dedicated to issues and concerns of seniors may also be promoted during programming on the channel.

### CROSS REFERENCE OF RELATED APPLICATIONS

This application is a continuation-in-part of application Ser. No. 11/277,341 Filed Mar. 23, 2006.

### FIELD OF THE INVENTION

The embodiments of the present invention relate to a television station for senior citizens. More particularly, the embodiments relate to a television station and associated conventions dedicated to benefiting senior citizens.

### BACKGROUND

All too often senior citizens are forgotten or unattended to by society and left to fend for themselves. Unfortunately, senior citizens are one class of citizens that need more assistance rather than less. Senior citizens in the United States now number approximately 40 million. This number is growing rapidly as the baby boomers reach 65 years old. In addition, the numbers of seniors will continue to increase as life expectancy continues to increase.

Senior citizens are provided few advantages based on their age. Social security, discounts on goods and services and Medicare are the typical benefits provided to seniors. However, social security and Medicare are routinely in flux as the target of possible budget cuts. Clearly, society owes more to its seniors than it currently provides. Fortunately, there are individuals and companies throughout our society that desire to assist seniors but are unable to get the message to seniors in a routine and consistent manner.

Television is one medium that has burgeoned into a vast-reaching enterprise allowing the masses to entertain and educate themselves. Seemingly there are one or more channels to placate the needs of all segments of society. Sports channels, cooking channels, news channels, movie channels, animal channels, history channels and cartoon channels are only a few of the myriad of channels available to cable or satellite subscribers. To date, there are no channels dedicated to seniors or the problems and concerns they face.

A senior citizen channel is advantageous for seniors as it provides a routine and easily located medium offering programming relevant to the issues facing seniors. Moreover, as described in greater detail below, advertisers and content providers benefit by targeting a very large and wealthy segment of society.

It would also be advantageous to arrange routine conventions dedicated to the senior citizens and their unique interests and concerns. Ideally, the conventions are held annually or semi-annually and are promoted via the senior citizen channel.

Thus, there is a need for a television station and corresponding conventions dedicated to the issues facing seniors. Moreover, the dedicated station can provide interactive capabilities for seniors.

### SUMMARY

Accordingly, a first method embodiment of the present invention is directed to operating a dedicated senior citizen channel comprising: developing senior-based content, including entertainment and educational programming; broadcasting the senior-based content over a pre-established radio or satellite frequency, or via a wire or cable, said content receivable and displayable by a television set, personal computer or hand-held device; providing opportunities for third parties to place advertisements promoting senior-related goods and services wherein the advertisements are specifically related to subject matter of the programming during which the advertisements are shown; and broadcasting promotional and informative content regarding said conventions dedicated to senior related issues and concerns wherein said promotional and informative content is specifically related to subject matter of the programming during which the promotional and informative content is shown.

The senior-based content may be disseminated via radio or satellite signals receivable by electronic devices, such as television sets and personal computers. The senior-based content may also be disseminated over conventional cables connected to suitable electronic devices. The underlying purpose of the embodiments of the present invention is to provide a vehicle for senior citizens to passively receive entertainment programming, educational programming and access to goods and services. A second purpose is to provide a vehicle for senior citizens to become actively involved in the entertainment and education while being presented with relevant goods and services.

The convention aspect allows seniors to gather in a common location (e.g., Las Vegas) such that they may interact with other seniors while interacting with various vendors providing goods and/or services directed to seniors and their unique interests and concerns.

Other variations, embodiments and features of the present invention will become evident from the following detailed description, drawings and claims.

### BRIEF DESCRIPTION OF THE DRAWINGS

FIG. 1 illustrates a flow chart detailing one embodiment of the present invention;

FIG. 2 illustrates a programming chart detailing one day of sample programming; and

FIG. 3 illustrates a flow chart detailing an alternative embodiment of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

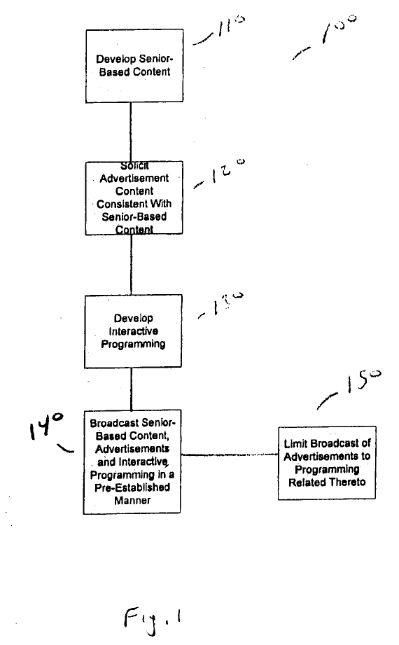

Reference is now made to the figures wherein like parts are referred to by like numerals throughout. FIG. 1 shows a flow chart 100 of a first embodiment of the present invention. Initially, at step 110, senior-based content is developed. Senior-based content can come in any number of forms, including entertainment and education programming. Issues relevant to seniors are plentiful and some are disclosed below. Heretofore, senior based content is not available in a single easily accessible location. As described below, the embodiments of the present invention fulfill this need any many others.

Politics are a serious issue for seniors. Suitable political content may include candidate platforms, voting dates, voting locations and other political information. In one embodiment, the political information is also limited to senior-based issues such that seniors are specifically educated on the issues of particular relevance to their demographic. Political content may be broader as well. For example, political content may include bills and other legislative measures which, if passed, may impact directly, or indirectly, seniors and their lifestyle.

Healthcare is arguably the single most important political issue to seniors. Medicare is one aspect of the healthcare system that is particularly relevant to seniors. The content related to Medicare may include means for securing Medicare, available coverage, procedures for utilizing Medicare and related issues. Importantly, with the new complicated Medicare procedures, the content may provide instructional information related to utilizing the same. Programming related to self-insurance, including means for securing self-insurance and scope of coverage, is also suitable. Self-insurance provides seniors with alternative and/or better coverage than Medicare alone.

Healthcare programming can be used to educate seniors on relevant diseases, diagnosis, remedies and prescription drugs. The programming may be very detailed thereby providing seniors with means for self-diagnosis. With seniors, early diagnosis is critical to overcoming medical problems and extending life expectancy. Another aspect of healthcare involves programming related to medical doctors, such as their qualifications, insurance requirements, etc.

Social security content may also be developed in conjunction with healthcare and Medicare. Social security programming, like Medicare programming, can assist seniors with the complexities and benefits and pitfalls of social security. Programming regarding the quality of local nursing homes and related care facilities can also be provided.

Other government agencies, such as the DMV and Veteran's Administration, may facilitate the development of content. For example, the DMV can develop content designed to assist seniors with renewing driver's licenses and locating the nearest DMV branch.

Another genre of programming can relate to educating seniors regarding scams and similar offenses which have historically targeted seniors. Entire shows may be dedicated to educating seniors with respect to known scams and the things to look for to identify new scams. Similarly, the programming may be used to educate seniors regarding the downside of legal risks, like gaming. Low and middle class seniors can be tempted by slot machines and similar gaming devices. Accordingly, a program can be dedicated to counseling seniors on the pitfalls to such activities.

Programming related to cooking can be developed to assist seniors with preparing inexpensive and healthy meals. Such programming can be developed to assist seniors with eating healthy thereby working hand-in-hand with the healthcare content.

Social programming is another invaluable service that may be presented via the embodiments of the present invention. Social programming can advise seniors of dates and times for singles gatherings, lessons with arts and crafts, game play (e.g., bridge and bingo), etc.

Sitcoms, movies, game shows and similar theatrical material of the appropriate subject matter may provide a foundation for senior entertainment content.

Programming can be based on any desired or suitable senior content such as available housing, employment, volunteer opportunities, exercise and hygiene. Such a dedicated channel is ideal for seniors. Seniors are often immobile and unskilled with computers so that a dedicated television channel provides a natural medium to which a majority of seniors have access. Programming of particular relevance can be taped or otherwise stored for later viewing by seniors.

To enhance the experience for seniors, at step 120, advertising content commensurate with the entertainment and education programming is developed. Advertisements are predicated on benefiting seniors by presenting goods and services especially useful for seniors. Advertisements for goods may promote medicines, food and clothing attractive for seniors. Advertisements for services may promote tax preparation, healthcare, insurance and related services. Indeed, the goods and services which may be promoted are limitless as long as they are useful to the seniors. Given the constraints of mobility of seniors, preferably, the advertisements are related to local providers of goods and services. In other words, while some advertisements may be national in scope, a majority of the advertisements should be local in nature to allow the viewing seniors to take first hand advantage of the same.

In one embodiment, as shown at 150, the advertisements relate to the programming being disseminated. That is, during healthcare programming, only healthcare advertisements are shown. In this manner, seniors are able to determine in a convenient fashion when advertisements of interest will be aired. Such an embodiment permits seniors to develop a programming schedule of particular relevance to their needs. This embodiment is also beneficial to the advertisers since they are able to target a very specific demographic. No such system is currently employed. While advertisers currently attempt to target certain demographics based on programming, they do it in an inexact manner. For example, during soap operas, advertisements typically target females because females are more likely than males to watch soap operas. However, there is no assurance that the females will be interested in the products or services being advertised. Contrarily, this embodiment of the present invention provides advertisers with greater certainty as the viewers are watching programming directly related to the advertised product or service. Thus, the advertiser knows in advance that the viewers are interested in the premise or concept of the product or service.

At step 130, interactive programming is developed. Interactive programming consists of programming designed to allow seniors to participate, at some level, in the programming. In one example, a live show targeting seniors is produced and filmed for live or taped airing at a local facility frequented by seniors. A casino, bingo hall or similar facilities are suitable choices. Such facilities cater to seniors and will benefit financially by attracting large numbers of seniors to watch and participate in the programming depending on the programming content. Specifically, a talk show dedicated to seniors may be taped in a local casino allowing seniors to form an audience and allowing the casino to increase foot traffic.

Further interactive programming provides an avenue for seniors to utilize the channel as a conduit to express concerns or complaints. Toll free numbers provided during various programs allow seniors to contact live operators to express concerns or complaints, typically related to the programming during which the toll free number is distributed. In one example, seniors are able to contact a toll free number regarding Medicare issues, such as double billing. Personnel at the channel may then pass on the information to the corresponding state and/or federal government agency. Thus, the channel acts like a go between such that seniors do not have to waste time or energy maneuvering through conventional, inefficient methods of contacting the agency directly. In this manner, the government or other entities benefit directly from the reporting provided by the seniors. Any industry interested in receiving unbiased customer feedback can utilize the senior channel to collect senior feedback via the channel.

At step 140, programming is broadcast, via wired and/or wireless means, to television sets and other electronic devices. The programming can be received by computers, cell phones, personal digital assistants and similar hand-held devices. In one embodiment, senior-based content, selected by the senior, is routinely e-mailed or transmitted in text and/or video format to electronic devices possessed by the senior. For example, a senior may select Medicare updates. As a result, the senior receives Medicare updates via e-mail or other transmission to the senior's selected devices. This embodiment allows the senior to easily receive relevant information without having to conduct Internet searches, sift through written documents or otherwise attempt to locate the relevant information. The information may also be mailed for those seniors who do not own a computer of are not computer savvy.

Money-raising promotions directed at seniors may also be advertised and/or disseminated over the channel airing the senior-based content. Such promotions are ideally operated by seniors for seniors. Promotions may be based on golf outings, bake sales and the like. The promotions may be designated for specific geographic regions, classes of seniors or general senior charities. In this manner, seniors are able to participate in fund-raising activities or learn of how to benefit from the fund-raising efforts of others.

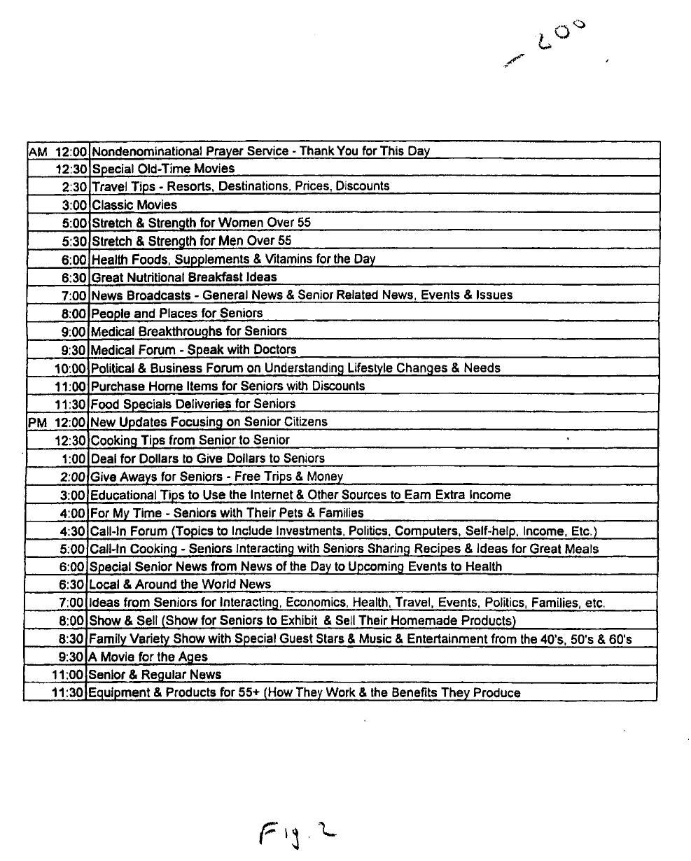

FIG. 2 shows a proposed programming schedule 200 for a single day. As detailed herein, the content is directed to seniors. While the schedule 200 depicts 24 hour programming, programming during low peak hours (1:00 am-4:00 am) may include reruns or infomercials pitching products useful to seniors. The channel may also be down during the no-peak hours such that no programming is shown.

Since programming consists of subject matter pertinent to the needs of seniors on an ongoing basis, current events and other vital information happening on a day-to-day basis may also create the need for a fluid programming schedule that contains operating changes and additions as required. In other words, although a programming schedule is set, it is subject to change should important senior information becomes available.

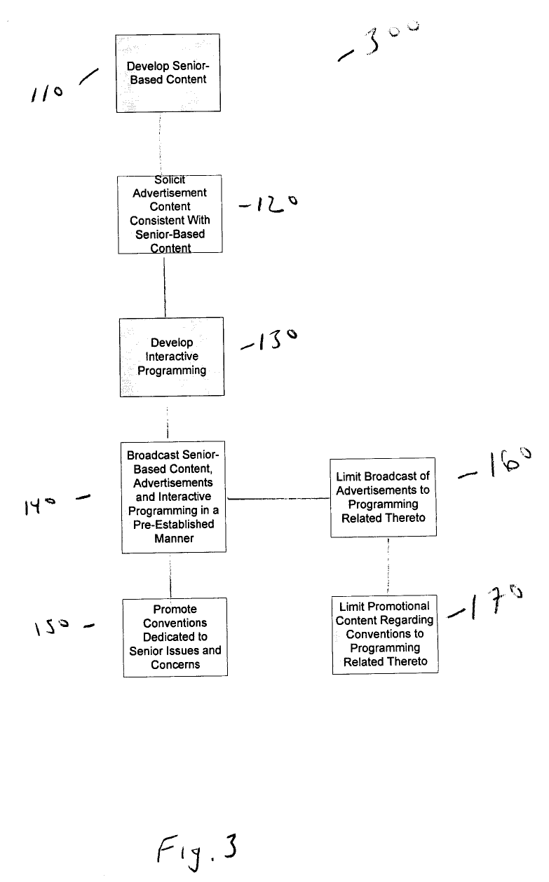

FIG. 3 shows a flow chart 300 detailing another embodiment of the present invention whereby at 160 one or more conventions tailored to issues and concerns of seniors are promoted on or via the senior channel. In this manner, seniors are assured of becoming aware of the convention and the vendors that will be in attendance. Promotions are used to encourage senior attendance based on the vendors and functions being organized at the convention. Otherwise, without the senior channel promotions many seniors may never know that a convention dedicated to senior issues and concerns was taking place. That is, many seniors are not computer savvy and would thus fail to learn of the convention via the Internet. Also, many seniors view traditional mail with some skepticism as many scams directed at seniors are undertaken via mail. Consequently, with the method disclosed herein seniors are able to gather accurate and believable content regarding the convention.

Like above, at 170 it is also advantageous to promote certain features (e.g., vendors, goods or services) during specific programming related thereto. For example, if a vendor dedicated to selling life insurance is committed to being at the convention, a promotional ad regarding the vendor may be aired during a televised show dedicated to life insurance for seniors. Therefore, the vendor selling life insurance is sure to target the specific demographic of interest. Similarly, those seniors interested in life insurance are more likely to become aware of that a convention for seniors is being held at a specified time and location. Information may also be transmitted to seniors via e-mail or text message or with known methodologies.

The conventions may take place annually or semi-annually in any location, including Las Vegas, Orlando or Phoenix. International destinations may also be utilized to host the conventions. The conventions are dedicated to providing information, goods and services that are of specific interest to seniors. In addition, the conventions provide an ideal retreat for seniors to get together to tackle similar concerns, address similar issues or just discuss issues they have in common. The conventions are also used to promote the television station. For example, besides advertisements displayed at the convention location, the television station retains a booth and mans it with staff able to explain the television station to attendees.

By combining the television station and convention, seniors are benefited tremendously, because they like no other demographic, are more likely to find it difficult to digest the vast amounts of information that we are inundated with on a daily basis. Gathering and disseminating senior information via a television station and associated conventions is an ideal platform to target seniors. Moreover, convention attendee registrations provides data that is used to better define the interests and concerns of seniors by race, creed, gender, age, etc. Based on the collected data, the television show programming and the convention topics can be adjusted to better fit the interests and concerns of the seniors.

Although the invention has been described in detail with reference to several embodiments, additional variations and modifications exist within the scope and spirit of the invention as described and defined in the following claims.

I claim:

1. A method of operating a dedicated senior citizen channel comprising:
developing senior-based content, including entertainment and educational programming;
broadcasting the senior-based content over a pre-established radio or satellite frequency, or via a cable, said content receivable and displayable by a television set, computer or hand-held device;
providing opportunities for third parties to place advertisements promoting senior-related goods and services wherein the advertisements are specifically related to subject matter of the programming during which the advertisements are shown; and
broadcasting promotional and informative content regarding associated conventions dedicated to senior related issues and concerns wherein said promotional and informative content is specifically related to subject matter of the programming during which the promotional and informative content is shown.

2. The method of claim 1 further comprising disseminating senior-based content related to healthcare, politics, housing, governmental agencies, cooking and social activities.

3. The method of claim 1 further comprising disseminating senior-based content comprising sitcoms, game shows and movies.

4. The method of claim 1 further comprising providing interactive programming.

5. The method of claim 1 further comprising disseminating senior-based content via mail and/or e-mail.

6. The method of claim 5 further comprising providing means for seniors to dictate the subject matter of the mail and/or e-mail.

7. The method of claim 5 further comprising providing the e-mails via a wired and/or wireless system.

8. A method of operating a dedicated senior citizen channel comprising;
developing senior-based content, including entertainment and educational programming;
broadcasting the senior-based content over a pre-established radio or satellite frequency, or via a cable, said content receivable and displayable by a television set, computer or hand-held device;
providing interactive senior-based content;
providing opportunities for third parties to place advertisements promoting senior-related goods and services wherein the advertisements are specifically related to subject matter of the programming during which the advertisements are shown;
arranging conventions dedicated to issues and concerns or seniors; and
broadcasting promotional and informative content regarding said conventions wherein said promotional and informative content is specifically related to subject matter of the programming during which the promotional and informative content is shown.

9. The method of claim 8 further comprising disseminating senior-based content related to healthcare, politics, housing, governmental agencies, cooking and social activities.

10. The method of claim 8 further comprising disseminating senior-based content comprising sitcoms, game shows and movies.

11. The method of claim 8 further comprising disseminating senior-based content via mail and/or e-mail.

12. The method of claim 11 further comprising providing means for seniors to select the subject matter of received mail and/or e-mail.

13. The method of claim 11 further comprising disseminating the e-mails via wired and/or wireless networks.

14. A method of operating a dedicated senior citizen channel comprising;
developing senior-based content, including entertainment and educational programming;
broadcasting the senior-based content over a pre-established radio or satellite frequency, or via a cable, said content receivable and displayable by a television set, computer or hand-held device;
providing opportunities for third parties to place advertisements promoting senior-related goods and services wherein the advertisements are specifically related to subject matter of the programming during which the advertisements are shown;
broadcasting promotional and informative content regarding associated conventions dedicated to senior related issues and concerns wherein said promotional and informative content is specifically related to subject matter of the programming during which the promotional and informative content is shown.
disseminating senior-based content, including the promotional and informative content regarding the conventions, via mail and/or e-mail.

15. The method of claim 14 further comprising disseminating senior-based content related to healthcare, politics, housing, governmental agencies, cooking and social activities.

16. The method of claim 14 further comprising disseminating senior-based content comprising sitcoms, game shows and movies.

17. The method of claim 1 further comprising providing interactive programming.

18. The method of claim 14 further comprising providing means for seniors to dictate the subject matter of the mail and/or e-mail.

19. The method of claim 14 further comprising providing the e-mails via a wired and/or wireless system.
